(19) United States
(12) Patent Application Publication
(10) Pub. No.: US 2025/0315826 A1
(43) Pub. Date: Oct. 9, 2025

(54) SECURE FACILITATION OF A SECONDARY TRANSACTION

(71) Applicant: SnapPays Mobile, Inc. (CA) dba Papaya, Sherman Oaks, CA (US)

(72) Inventors: Jason Meltzer, Pasadena, CA (US); Yuriy Kulibaba, Chatsworth, CA (US); Patrick Kann, Sherman Oaks, CA (US)

(73) Assignee: SnapPays Mobile, Inc. (CA) dba Papaya, Sherman Oaks, CA (US)

(21) Appl. No.: 19/067,183

(22) Filed: Feb. 28, 2025

Related U.S. Application Data
(60) Provisional application No. 63/574,191, filed on Apr. 3, 2024.

(51) Int. Cl. G06Q 20/40

(52) U.S. Cl. CPC G06Q 20/401

(57) ABSTRACT

A payment system includes a first set of servers for a first website configured to provide a payment information form page, process payment information to determine a primary transaction status, and provide a confirmation page. The payment information form page configures a client device to accept payment information from a user, convey the payment information to the first set of servers, and store the payment information in a temporary storage location. The confirmation page, or a subsequent page reachable via the confirmation page, configures the client device to obtain a user decision regarding a secondary transaction, send the payment information to a second set of servers for a second website without requiring completion of another payment information form if the user decision is affirmative, and delete the payment information from the temporary storage location before, or upon, closure of the confirmation page or the subsequent page.

### CROSS-REFERENCES

The present application claims benefit of provisional U.S. Application 63/574,191, filed 2024 Apr. 3 and titled “Systems and Methods for Securely and Temporarily Retaining Sensitive Data in a Web Browser for Reuse” by inventors Jason Meltzer, Yuriy Kulibaba, and Patrick Kann, which is hereby incorporated herein by reference in its entirety.

### TECHNICAL FIELD

The present disclosure relates to secure payment processing systems, and more particularly to a system and method for temporarily storing encrypted information in a web browser to facilitate secondary transactions without requiring re-entry or redundant review of sensitive information.

### BACKGROUND

An internet browser, aka “web browser”, is a software application that enables users to retrieve and access information on the World Wide Web. A web browser may interpret and display content from websites, i.e., collections of web pages and related content identified by a common domain name and published on at least one web server. Web pages are structured documents each identified by a distinct Uniform Resource Locator and having as their core element a text file written in HyperText Markup Language (HTML), which specifies the content of the page (typically text, images, videos, and other multimedia elements), optionally with reference to Cascading Style Sheets (CSS) and JavaScript programs that can exist as separate files or can be embedded in the core element.

As part of their processes for communicating with servers and displaying web pages, web browsers implement various standards for caching resources, executing scripts, maintaining HyperText Transfer Protocol (HTTP) cookies, and tracking values of internal variables. A typical web browser may include various components such as a rendering engine, a JavaScript interpreter, and a network module to handle different aspects of web page loading and display. Web browsers may run on various user devices including personal computers, smartphones, tablets, and other internet-connected devices.

When the browser displays a page from a website, the user device is operating as a client or “front end” device for the website. The set of one or more servers handling communications from the user device to the website and providing the web page and associated content, operates as the back end for the website. The back-end processes of many websites include providing product information, tracking inventory, creating customer accounts, accepting orders, processing payments, initiating deliveries, and routing customer service requests.

An illustrative web page may include forms for collecting information. Web forms enable websites to serve a page to a browser allowing a user to enter data into fields and to then submit that data to the back end. With the advent of the Secure Sockets Layer (SSL) protocol in 1995, such form submissions could be encrypted such that only the authorized back-end servers could read the transmitted data.

Autofill was introduced in 2005 (see, e.g., US2006/0179404A1) as a convenience to allow users of web browsers to reduce typing of data into web forms. Autofill technologies in browsers typically store the user data on the machine running the web browser, although some technologies pair this with server-side storage that a user can access across separate user devices. A hallmark of autofill technology is that it enables long term storage of the user data for automatic entry into any web form, though the user is typically required to review the web form before submission to confirm that the autofill process was successful.

When dealing with sensitive information in general, and payment information in particular, various newer technologies have emerged for conducting secure transactions. These include card tokenization and digital wallets.

Card tokenization typically allows a card processing merchant to charge a payment method multiple times without the need to retain the primary account number or other cardholder data. Rather, the merchant receives a token from the transaction processor, gateway, or network that the merchant can use to issue new payment authorizations. Some token-based systems undesirably allow for the detokenization of the data, enabling the original cardholder data to be recovered from the token. Otherwise, such systems require an intermediary to store and secure the customer information associated with each token, complicating the transaction process and creating potential vulnerabilities.

Digital wallets such as Apple Pay or Google Pay are becoming more commonplace. Digital wallets allow users to transact using an underlying credit or debit card without sharing the payment details of that card. For merchants that accept digital wallets, users do not need to enter card details such as primary account number, expiration date, or address. However, the digital wallet is maintained by an intermediary who interacts with the merchants, requiring that the merchant's card processing systems be modified to involve an additional participant in the transaction process. The digital wallet data is long lived and typically distributed among many computing systems.

As e-commerce continues to grow, innovative payment technologies will play an important role in shaping the future of online retail. Balancing robust security protections with intuitive user experiences represents an ongoing challenge and opportunity for advancement in this space.

### SUMMARY

Accordingly, there are provided herein secure payment systems and methods and associated information storage media to facilitate secondary transactions. One illustrative payment system includes a first set of one or more servers for a first website, the first set of servers collectively configured to: provide a payment information form page; process payment information to determine a primary transaction status; and provide a confirmation page. The payment information form page configures a client device to: accept payment information from a user; convey the payment information to the first set of one or more servers; and store the payment information in a temporary storage location. The confirmation page, or a subsequent page reachable via the confirmation page, configures the client device to: obtain a user decision regarding a secondary transaction; send, without requiring completion of another payment information form, the payment information to a second set of one or more servers for a second website if the user decision is affirmative; and delete the payment information from the temporary storage location before, or upon, closure of the confirmation page or the subsequent page.

An illustrative method for facilitating secondary transactions includes: rendering a payment information form page for a first website; accepting via the payment information form page payment information from a user; conveying the payment information to a first set of set of one or more servers for the first website; storing the payment information in a temporary, local storage location; displaying a confirmation page for the first website; obtaining via the confirmation page or via a subsequent page reachable from the confirmation page, a user decision regarding a purchase transaction from a second website; sending, without requiring completion of a payment information form for the second website, the payment information to a second set of one or more servers for the second website if the user decision is affirmative; and deleting the payment information from the temporary storage location before, or upon, closure of the confirmation page or the subsequent page.

An illustrative non-transitory computer-readable medium stores instructions that, when incorporated in a confirmation form page of a first website accessed by an internet browser on a client device, configures a processor to: obtain a user decision regarding a secondary transaction; send, if the user decision is affirmative and without requiring completion of a payment information form associated with a second website, payment information previously stored by the internet browser in a temporary, local storage location in response to a primary transaction with the first website; and delete the payment information from the temporary storage location before, or upon, closure of the confirmation page.

Another illustrative non-transitory computer-readable medium has a code snippet that, when incorporated in a payment information form page of a first website accessed by a client device, configures an internet browser on the client device to store the payment information in a temporary storage location accessible via a confirmation page, or a subsequent page reachable via the confirmation page, for use in a secondary transaction on a second website without requiring completion of a payment information form for the second website.

Another illustrative payment system includes a first set of one or more servers for a first website having at least one page that configures a client device to store, in a temporary storage location, encrypted payment information encrypted using a public key associated with a second website, the first website further having a subsequent page that configures the client device to: obtain a user decision regarding a secondary transaction; send the encrypted payment information from the temporary storage location to a second set of one or more servers for a second website if the user decision is affirmative; and delete the payment information from the temporary storage location before, or upon, closure of the subsequent page.

The foregoing systems, methods, and media may include any suitable one or more of the following optional features: 1. the temporary storage location holds the payment information in encrypted form and said storing includes using a public key to generate the encrypted form. 2. the public key is associated with the second website. 3. said sending includes transmitting the encrypted form of the payment information retrieved from the temporary storage location. 4. the client device employs an internet browser to render the payment information form page and the confirmation page. 5. the temporary storage location is memory allocated to a local variable in a runtime environment for the internet browser. 6. the temporary storage location is an HTTP cookie associated with the first website. 7. the temporary storage location has a timeout that triggers deletion of the payment information if not previously deleted. 8. the confirmation page, or a subsequent page reachable via the confirmation page, configures the client device to delete the payment information upon determining that the user decision is negative. 9. said rendering, accepting, conveying, and storing operations are implemented by an internet browser responsive to instructions for providing the payment information page. 10. said displaying, obtaining, sending, and deleting operations are implemented by the internet browser responsive to instructions for providing the confirmation page or the subsequent page. 11. the subsequent page configures the client device to delete the payment information upon determining that the user decision is negative.

### BRIEF DESCRIPTION OF FIGURES

FIG. 1 shows elements of an illustrative computer network, such as the internet.

FIG. 2 shows a browser window displaying an illustrative confirmation page with secondary transaction options.

FIG. 3 is a flow diagram of an illustrative method for securely facilitating secondary transactions.

FIG. 4 is a block diagram of an illustrative client device.

FIG. 5 shows HTML code for an illustrative payment form.

FIGS. 6A-6B show illustrative JavaScript code for ephemeral storage.

FIG. 7 shows HTML code for an illustrative confirmation page.

FIG. 8 shows JavaScript code for an illustrative secondary transaction widget.

### DETAILED DESCRIPTION

The drawings and following description do not limit the disclosure, but on the contrary, they provide the foundation for one of ordinary skill in the art to understand all modifications, equivalents, and alternatives falling within the scope of the claim language. Payment transactions are used to provide an explanatory context, but the principles can be applied to any situation where it is desired to facilitate secure reuse of sensitive information, including usernames, passwords, identity information, contact information, account numbers, transaction history, medical information, etc.

The present disclosure relates to systems and methods for securely facilitating secondary transactions in an online environment. In particular, the disclosure provides a system that enables secure, temporary storage of sensitive user data, such as payment information, in a web browser for subsequent use in secondary transactions. This system may advantageously, without requiring intermediaries or complex modifications to existing transaction processes, eliminate the need for users to re-enter their sensitive user data for secondary transactions on different websites, thereby enhancing user convenience and transaction efficiency.

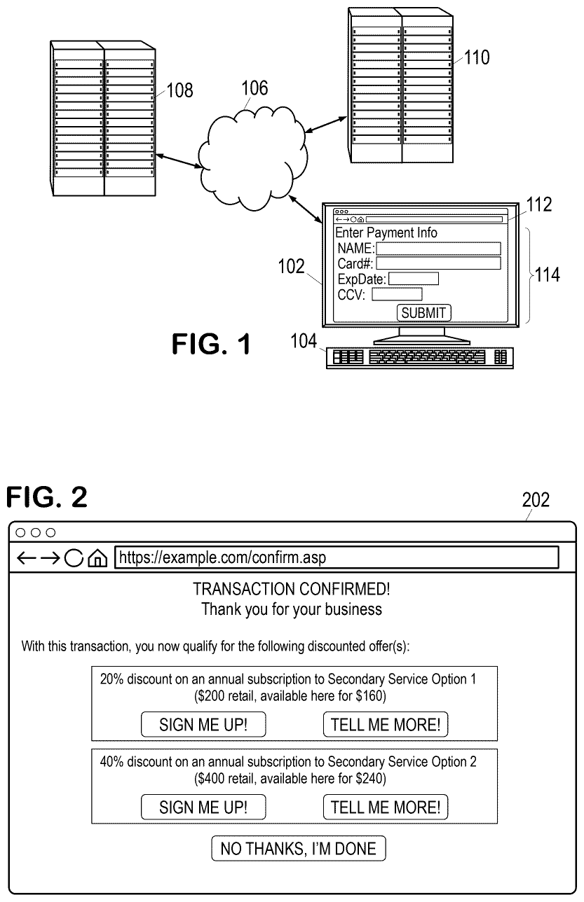

FIG. 1 shows an illustrative computer network including a client device 102, a cloud 106 representing an interconnected arrangement of network nodes, a first server rack 108 representing a set of one or more servers for a first website, and a second server rack 110 representing a set of one or more servers for a second website. The illustrated client device 102 is a personal computer equipped with a keyboard 104 and a screen displaying a browser window 112. The browser window 112 is shown accessing a payment information form 114 on the first website. Client device 102 can take other forms, including tablet computers, smartphones, e-readers, smart watches, gaming consoles, and smart TVs. More generally, client device 102 can be any electronic device capable of running a browser for accessing and interacting with websites.

The server racks 108, 110, and network nodes represented by cloud 106 may include network hubs, switches, bridges, firewalls, servers, and other such components configured to send and receive network packets over wired, wireless, and optical communications links. The website servers may be physical computers but may alternatively be emulated (virtual) computers hosted on dedicated hardware or on fungible elements of a distributed computing system. Though any given website may appear to a user or client computer as though it is published on a single, physical computer, in practice multiple computers typically share responsibility for responding to requests and accepting data communicated to the website, enabling the associated network traffic to be more efficiently distributed among available computer resources. The set of one or more servers for the first website are collectively configured to provide a payment information form page, to process payment information to determine a primary transaction status, and to provide a confirmation page. The payment information form page configures the client device to accept payment information from a user, to securely convey the payment information to the first set of servers, and to securely store the payment information in a temporary storage location.

Examples of a first website that may provide a form page for collecting payment information and/or other sensitive user information include:
1. Healthcare portals: Websites operated by hospitals, clinics, or healthcare systems that allow patients to pay medical bills online. These portals may integrate with insurance providers and offer options for payment plans.
2. Utility company websites: Sites for electricity, water, gas, or telecommunications providers where customers can view and pay their monthly bills.
3. Educational institutions: University or college websites that accept tuition payments, dormitory fees, or other education-related expenses.
4. Mortgage servicer portals: Websites operated by banks or mortgage companies where homeowners can make monthly mortgage payments or pay property taxes and insurance.
5. Credit card company sites: Online platforms where cardholders can pay their credit card bills, view statements, and manage their accounts.
6. E-commerce platforms: Large online marketplaces like Amazon, eBay, or Etsy, as well as individual retailer websites, where consumers can purchase physical goods.
7. Digital content providers: Websites selling digital products such as software, e-books, music, or video content, including subscription-based streaming services.
8. Online service providers: Websites offering various services such as web hosting, cloud storage, or professional services that require regular payments.
9. Government portals: Websites operated by local, state, or federal government agencies for paying taxes, fines, or fees for various services.
10. Charitable organizations: Websites of non-profit organizations that accept online donations.
11. Travel booking sites: Platforms for booking flights, hotels, rental cars, or vacation packages.
12. Insurance company portals: Websites where policyholders can pay premiums for various types of insurance.
13. Subscription box services: Websites offering regular deliveries of curated products, often on a monthly basis.
14. Online gaming platforms: Websites that sell video games or offer in-game purchases and subscriptions.
   In each of these cases, the website may present a payment information form to collect necessary details such as credit card numbers, expiration dates, security codes, and billing addresses. The specific design and implementation of these forms may vary, but they all serve the common purpose of securely collecting payment information to process transactions.

Many such websites wish to partner with otherwise unaffiliated providers of related services or products. For example, healthcare portals may wish to facilitate access to wellness services, health monitoring products, or exercise equipment. Utility companies may wish to facilitate access to automated payment providers, conservation-related services, or related products. Educational services may wish to facilitate access to financial services, tutoring platforms, or textbooks and other education-related resources. Mortgage and credit card companies may wish to facilitate access to investment counselors, credit reports, or online privacy services.

One way for such websites to facilitate such access is for them to provide options for a secondary transaction as the user is completing their primary transaction on the first website. While secondary transaction arrangements are not unknown, existing solutions typically require those users desiring the secondary transaction to complete another payment information form for the second website, which introduces undesired friction even if the user relies on an autofill technology. Such can be avoided if the first website conveys the user information, whether directly or via an intermediary, to the second website, but such arrangements are becoming complex and undesirable given ever-stricter regulations regarding user control of protected consumer information.

To overcome these issues, the client device in the disclosed system conducts the first website's usual payment process, but with a slight alteration that causes the browser to temporarily retain a copy of the payment information, preferably in an encrypted form that can only be decrypted by the second website. When the primary transaction completes, the client device may provide a confirmation page such as that shown by the browser window 202 in FIG. 2. If the user consents to a secondary transaction, the client device obtains the encrypted information from temporary storage and sends it to the second website without requiring the user to complete or review a second payment information form page.

Referring again to FIG. 1, the payment information form page 114 is configured to accept payment information from a user via the client device 102. The payment information may include details such as the user's name, credit card number, expiration date, security code, and billing address. The form page 114 may be designed to securely collect this information in a manner that complies with applicable data protection and privacy regulations. Once the user has entered their payment information into the form page 114 and submitted it, the client device 102 conveys the payment information to the first set of servers 108 for the first website.

As explained further below, the client device 102 is configured to store the payment information concurrently with the conveyance of the payment information to the first set of servers 108. In some cases, the client device stores the payment information in a temporary storage location such as, e.g., memory allocated to a local variable in the runtime environment for the web browser.

Upon receiving the payment information, the first set of servers 108 processes the information to determine a primary transaction status. This processing may involve various steps such as validating the payment information, authorizing the transaction with a payment gateway, and updating the user's account balance or transaction history. When the primary transaction status indicates success, the client device may be configured to progress to the confirmation page. If the primary transaction status indicates that the processing was unsuccessful, the client computer may be configured to again display the payment information form page 114 with an indication that the information submission failed. Where the first set of servers 108 is able to identify specific errors, the client device may highlight the associated portions of the payment information form. The client device may permit the user to correct the entries in the form before resubmission.

Referring to FIG. 2, upon successful processing of the primary transaction, the first set of servers 108 provides a confirmation page displayed on the browser window 202 of the client device 102. The confirmation page may include details of the primary transaction, such as the transaction amount, date, and status. In some cases, the confirmation page may also include a transaction reference number or other identifiers for the user's records.

In addition to providing details of the primary transaction, the confirmation page may also present options for a secondary transaction. Alternatively, or in addition, the confirmation page for the first website may have a subsequent page that configures the client device to obtain a user decision regarding a secondary transaction. This subsequent page may be reachable via the confirmation page and may present the user with additional options or information related to the secondary transaction. The subsequent page may be designed to facilitate user decision-making by providing detailed descriptions of the secondary transaction options, user reviews, pricing information, or any other relevant information.

These options may be related to the primary transaction or may offer entirely different products or services. For example, if the primary transaction involved payment of a utility bill, the secondary transaction options might include energy-saving devices, home maintenance services, or renewable energy subscriptions. In another example, if the primary transaction involved payment for a healthcare service, the secondary transaction options might include wellness services, health monitoring products, or exercise equipment.

The interface for a secondary transaction presented by the confirmation page or the subsequent page is referred to herein as a widget. The widget is configured to obtain a user decision regarding the secondary transaction. This may involve presenting the user with a simple yes/no choice, multiple options to select from, or a more complex decision-making interface. The user's decision may be captured through various user interface elements such as buttons, checkboxes, dropdown menus, or text input fields. If the user decision is affirmative, indicating that the user wishes to proceed with the secondary transaction, the confirmation page or the subsequent page configures the client device 102 to send the payment information to a second set of servers 110 for a second website. This sending operation is performed without requiring the user to complete another payment information form for the second website. Instead, the payment information previously stored in the temporary storage location in the client device 102 is retrieved and transmitted to the second set of servers 110. This process significantly reduces the friction typically associated with secondary transactions, enhancing user convenience and transaction efficiency.

If the user decision is negative, indicating that the user does not wish to proceed with the secondary transaction, the widget configures the client device 102 to delete the payment information from the temporary storage location. This deletion operation may be performed immediately upon determination of the negative user decision, ensuring that the payment information is not retained on the client device 102 longer than necessary. In other cases, the payment information may be deleted from the temporary storage location when the user closes or departs from the confirmation page or the subsequent page. This ensures that the payment information is not retained on the client device 102 beyond the current browsing session, further enhancing the security of the user's sensitive data. The temporary storage may be further assured using a timeout function, causing the stored payment information to be deleted if the user provides no decision and fails to close or depart from the relevant page before the timer expires.

An iframe, or inline frame, is an HTML document embedded inside another HTML document on a website. The iframe HTML element can be used to insert content from another source (in this case, the widget for the second website) into a web page. In the context of the present disclosure, the iframe may be used to embed the secondary transaction interface from the second website into the confirmation page of the first website. In some cases, the widget may be configured to communicate with the second set of servers 110 for the second website. This communication may involve sending and receiving data related to the secondary transaction, such as product details, pricing information, and user decisions.

A shadow document object model (DOM) is an alternative way to encapsulate the widget in the confirmation page and/or subsequent page reachable from the confirmation page. A shadow DOM offers many of the same advantages as an iframe, but may facilitate the widget's access to the temporary storage location of the stored payment information. In either case, the widget can be configured to display a user interface that is consistent with the look and feel of the first website. This may involve using similar colors, fonts, and layout styles, thereby providing a seamless user experience. The widget may also be responsive, meaning that it adjusts its size and layout based on the size of the user's screen or browser window. This responsiveness may enhance the usability of the secondary transaction interface on various devices, including desktop computers, laptops, tablets, and smartphones.

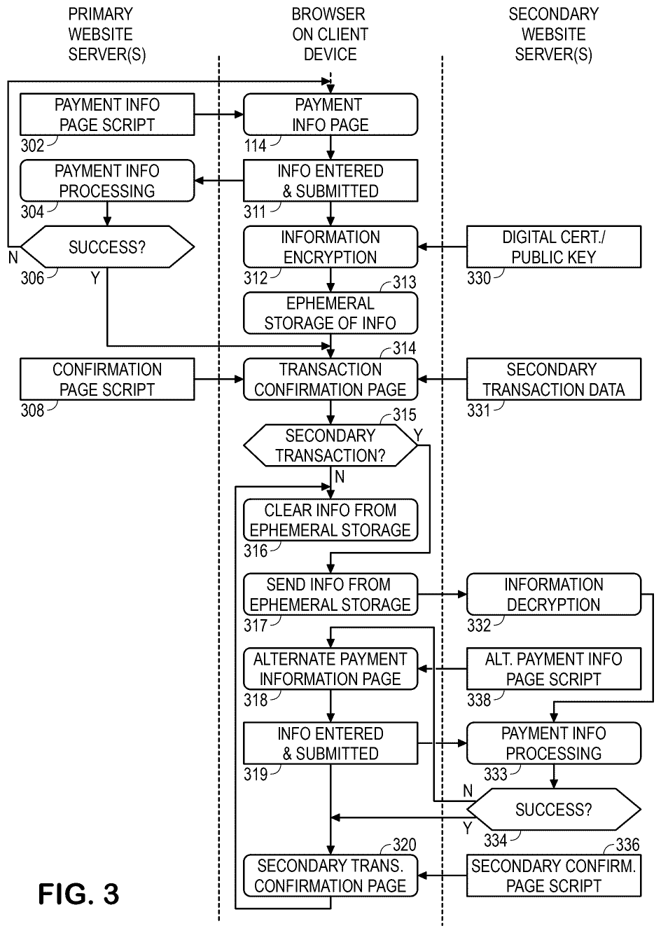

FIG. 3 is a flow diagram showing an illustrative distribution of the relevant content and processes across three domains. The center column shows the operations carried out by the browser on the client device. The left column shows the content and processes provided by the server(s) for the first website, and the right column shows the content and processes provided by the server(s) for the second website.

As a result of previous user actions (e.g., logging into the first website to initiate a primary transaction), the browser on the client device retrieves a payment information form page document 302 from the first website and renders a payment information form page 310 for the user. This form page 310 is configured to accept payment information from a user via the client device 102, but may also accept auto-fill content provided by the browser. In some aspects, the payment information may include details such as the user's name, credit card number, expiration date, security code, and billing address. The form page 310 may be designed to securely collect this information in a manner that complies with applicable data protection and privacy regulations.

Block 311 represents the information submitted by the user via the form. The browser conveys the payment information to a payment processing routine 304 for the first website. Concurrently, the browser may perform encryption 312 of the user information using a digital certificate or public key 330 for the second website, and may store the preferably encrypted user information in a temporary, local storage location (ephemeral storage 313). Given the ephemeral nature of the local storage, some implementations may omit the encryption operation.

Upon receiving the payment information, the payment processing routine 304 processes the information to determine a primary transaction status 306. This processing may involve various steps such as validating the payment information, authorizing the transaction with a payment gateway, and updating the user's account balance or transaction history. If the primary transaction status 306 indicates failure, the servers for the first website return the user to the payment information form page 310. When the primary transaction status 306 indicates success, the client device is configured to progress to the transaction confirmation page 314, which may be rendered based on a confirmation page document 308 from the first website servers. Document 308 may configure the client device to also retrieve secondary transaction data 331 from the servers for the second website. As one example, the confirmation page document 308 may include a URL that causes the client device to retrieve a widget from the second website, providing information regarding the user's options for a secondary transaction.

The confirmation page 314, or a subsequent page reachable via the confirmation page, configures the client device 102 to obtain a user decision 315 regarding a secondary transaction. If the user decision 315 is negative, indicating that the user does not wish to proceed with the secondary transaction, the client device may be configured to clear the stored user information from ephemeral storage. This deletion operation 316 may be performed immediately upon determination of the negative user decision, ensuring that the sensitive user information is not retained on the client device 102 longer than necessary. Optionally, the user information may be deleted from the temporary storage location when the user closes or departs from the confirmation page or the subsequent page. Further, a timeout function may be employed to delete the user information if no decision is provided within a predetermined time, e.g., 5 minutes, 10 minutes, 20 minutes, an hour, or some other suitable interval.

If the user decision 315 is affirmative, indicating that the user wishes to proceed with the secondary transaction, the client device accesses the temporary storage location to obtain the user information (or an encrypted form thereof) and send it to the servers for the second website. This sending operation 317 is performed without requiring the user to complete another payment information form for the secondary website. A decryption process 332 for the second website retrieves the payment information using a private decryption key. A payment processing routine 333 for the second website processes the information to determine a secondary transaction status 334. This processing may involve various steps such as validating the payment information, authorizing the transaction with a payment gateway, and updating the user's account balance or transaction history. If the secondary transaction status 334 indicates failure, the servers for the second website may direct the user to an alternative payment information form page 318, which the client device renders based on corresponding document 338 from the second website. The user may submit alternative payment information 319 via the form page, and the client device sends this information to the payment processing routine 333 for the second website.

When the secondary transaction status 334 indicates success, the client device is configured to progress to a secondary transaction confirmation page 320, which may be rendered based on a confirmation page document 336 from the second website servers. The secondary confirmation page 320 may include details of the secondary transaction, such as the transaction amount, date, and status. In some cases, the secondary confirmation page may also include a transaction reference number or other identifiers for the user's records.

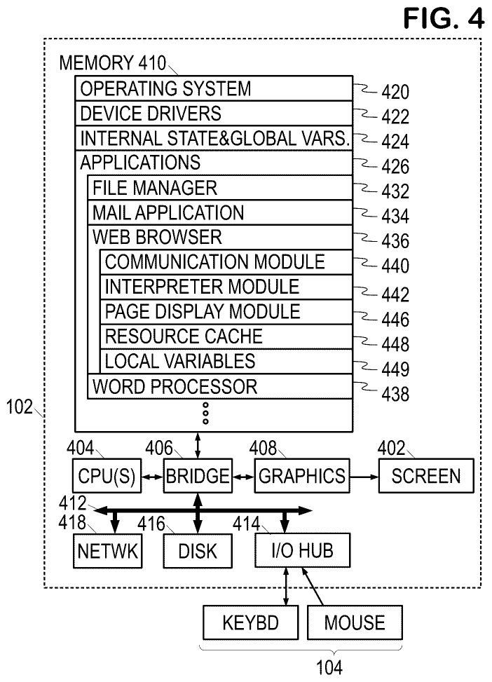

FIG. 4 provides additional detail for an illustrative client device 102. Client device 102 includes a display screen 402, a set of one or more central processing unit (CPU) cores 404, a bridge 406, a graphics module 408, a system memory 410, a peripheral bus 412, an I/O hub 414, nonvolatile information storage 416, and a network interface 418. Operation of the various components is configured by software modules stored in volatile memory 410, nonvolatile information storage (disk) 416, and/or remote systems accessible via network interface 418. During power-on or reset, a bootup process configures the processor core(s) 404 to retrieve operating system software 420 and device drivers 422 for storage in system memory 410, thereby making it possible for the processors to quickly access and execute the relevant instructions for displaying a user interface and interacting with a user. Memory 410 may further have portions 424 allocated for tracking the internal state of the client device and global variables intended for access by different software modules.

The screen 402 may be touch sensitive to accept user input and/or the processor core(s) may employ a keyboard or other input devices 104 to obtain user input. Bridge 406 provides high bandwidth communication between the processor core(s) 404, graphics module 408, memory 410, and peripheral bus 412. Graphics module 408 provides hardware to accelerate rendering of information on screen 402 and reduce computational demands on the processor core(s) 404. I/O hub 414 serves as a bridge between the peripheral bus 412 and the low-bandwidth components of the client device.

Most of the software for the system typically resides on a nonvolatile information storage medium 416, such as a magnetic disk, optical drive, solid state memory, or other known technique for providing high capacity, usually at a reduced cost and reduced access speed relative to system memory 410. The network interface 418 may couple to a computer network via a wired or wireless communication link, enabling the client device 102 to access web pages from various websites made available on the computer network. The websites and software may be retrieved as needed in response to user interactions. FIG. 4 shows examples of software applications that may be stored in allocated memory 426 for processor access, including: a system file manager 432, a mail application 434 for electronic mail, a web browser 436, and a word processor 438. Each of the applications may in turn distribute their functionality across several modules. For example, browser application 436 is shown having a communication module 440, an interpreter module 442, a display module 446, a resource cache 448, and allocated memory 449 for local variables for the browser's use, e.g., as part of the runtime environment.

Communication module 440 may retrieve web pages associated with URL's selected or manually entered by the user, and may return information (e.g., user data entered into a form) to the servers for the appropriate websites. The communication module 440 may support https and/or other security measures to ensure that the communications for retrieving and posting information are secure, ensuring the confidentiality, authenticity, and integrity of the information. In some cases, the previously discussed widget may use the communication module 440 to retrieve a public key associated with the second website. This public key may be used to encrypt the payment information before it is stored in the temporary storage location. The use of public key encryption ensures that only the second website, which holds the corresponding private key, can decrypt and access the payment information.

Interpreter module 442 may translate webpage documents into webpages for display, in the process implementing the scripts or other processes embedded in webpage documents such as, e.g., a widget script. The interpreter module 442 may translate the payment information form page document into the payment information page, and may later derive the confirmation page from a confirmation page document and any embedded secondary transaction data from the second website.

Display module 446 may handle the user interface controls for scrolling, selecting, and otherwise enabling the user to view and interact with the current webpage. Display module 446 may further capture text or other input from the user and display the results or effects on the screen.

The resource cache 448 is a component of the browser 436 that stores web content that is downloaded during the browsing process. This content can include HTML pages, CSS stylesheets, JavaScript scripts, images, HTTP cookies, and other resources that are required to display a web page. By storing this content in the resource cache 448, the browser 436 can quickly load the content when it is needed, without having to download it again from the internet.

Allocated memory 449 may hold local variables used by the browser for its various tasks. The scope of a given variable can be limited to a given webpage or website, or it can be made accessible for use in connection with other specified websites. The local variables can be integers, real numbers, characters, strings, or a defined variable type. The memory allocated for a given variable can be cleared and released when the variable is no longer needed.

As previously described, one of the local variables may serve as the temporary storage location for the payment information. The local variable may take the form of an encrypted string, and the encryption may be performed using the public key for the second website. Upon obtaining an affirmative user decision regarding a secondary transaction, the browser on the client device 102 may be configured to retrieve the encrypted payment information from the local variable and send it to the second set of servers 110 for the second website. This sending operation may be performed without requiring the user to complete another payment information form for the second website, thereby enhancing user convenience and transaction efficiency. The browser on the client device 102 may also be configured to delete the payment information from the local variables 449 before, or upon, closure of the confirmation page or a subsequent page reachable via the confirmation page. This deletion operation ensures that the payment information is not retained on the client device 102 longer than necessary, further enhancing the security of the user's sensitive data.

As an alternative, the temporary storage location may be an HTTP cookie associated with the first website. This cookie may be created and managed by the web browser 436 on the client device 102, providing another secure, temporary storage location for the payment information. As yet another alternative, the temporary storage location may be a data structure stored in the resource cache 448 of the browser 436. The payment information may be stored in the resource cache 448 in an encrypted form, using the public key retrieved by the communication module 440.

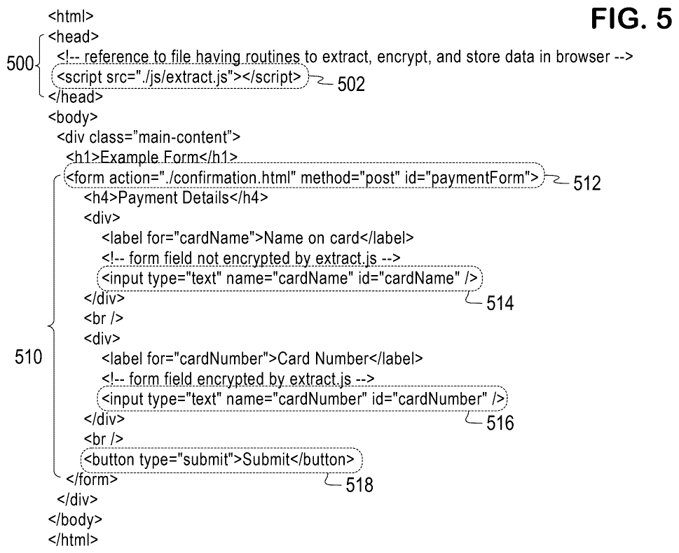

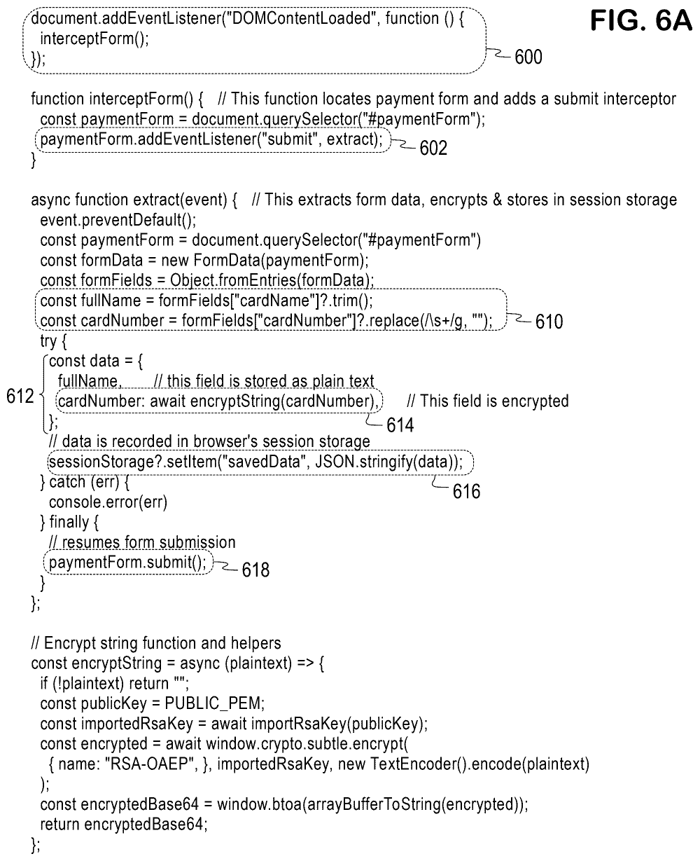

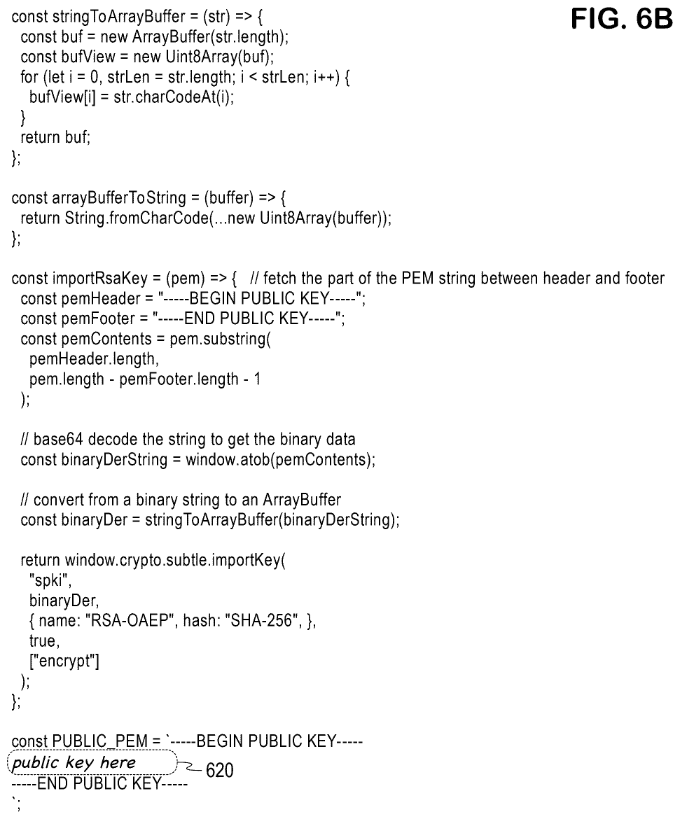

FIGS. 5-8 provide an example of an illustrative implementation. The HTML code shown in FIG. 5 provides a simplified payment information form page. The code includes a header element 500 and a body element. The header element 500 is generally intended for metadata and other content intended for machine processing rather than for information made visible to the user. For brevity, most of the information that would typically be found in a page's header element has been omitted, but in the present example header element 500 includes a script element 502 that embeds a file, here named extract.js, having executable code for ephemeral storage. The ephemeral storage code, or more specifically, the content of the extract.js file, is discussed below in connection with FIGS. 6A-6B.

The body element represents the visible content of the page. In FIG. 5, the body element includes at least a form element 510 to provide interactive controls enabling user-submission of information. The form element's opening statement 512 specifies an id attribute, a method attribute, and an action attribute. The id attribute is a unique name for the form. The method attribute specifies the HTTP method to be used when submitting the form for processing. The action attribute provides the URL that processes the form when it is submitted. In the illustrative implementation, the action attribute provides link to the confirmation page, providing a mechanism for submitting the form content to the servers for the first website as previously described.

The form element 510 further includes three input elements 514, 516, and 518. Input element 514 is a text input field for the user to provide their name as it appears on a credit card. Input element 516 is a text input field for the user to provide the account number appearing on their credit card. Input element 518 is a button for the user to click when ready to submit the payment information form.

The payment information form of FIG. 5 is notable for the embedded ephemeral storage script element 502. An illustrative implementation of the ephemeral storage code (extract.js) is shown in FIGS. 6A-6B. It begins with an addEventListener method 600 that calls a function when the browser processes the HTML code for the page. The called function is “interceptForm”, which in turn invokes an addEventListener method 602 of the payment form. Method 602 redirects the click of button 518 to the extract function.

The extract function includes lines 610 to capture the content of the text input fields in the constants fullName and cardNumber. The extract function then creates a data array 612 holding the constant fullName and an encrypted version of the cardNumber 614. Line 616 stores the data array 612 as an item named “savedData” in the sessionStorage property of the current page session. (Browsers are designed to clear the sessionStorage property when the browser tab or window is closed.) The extract function further includes line 618 to invoke the normal submit action once the savedData item has been created.

The remainder of the code in FIGS. 6A-6B shows helper functions for encrypting the card number 614. These are shown for completeness but are familiar to those in the art of HTML and JavaScript programming and need not be discussed further herein. Line 620 is a placeholder for the public key data that would normally be included here for the secondary transaction website.

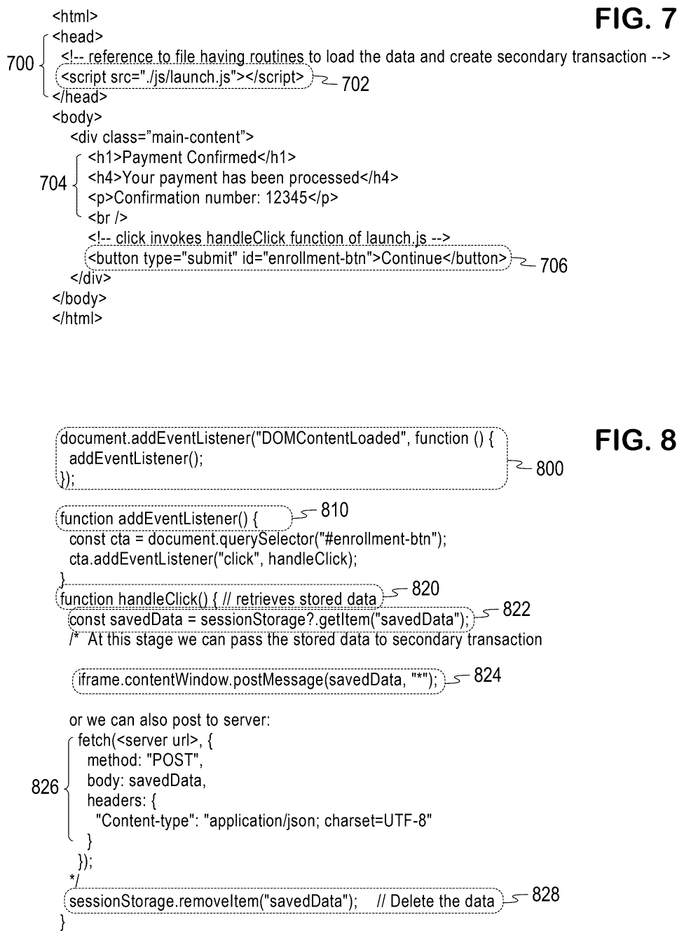

FIG. 7 provides the HTML code for an illustrative confirmation page that may be returned by the servers for the first website. The website may employ its standard mechanisms for processing the form information and generating the main content 704 of the confirmation page, e.g., an order confirmation number. As with the payment information page, the confirmation page includes a header element 700. For brevity, most of the information that would typically be found in a page's header element has been omitted, but in the present example header element 700 includes a script element 702 that embeds a file, here named launch.js, that provides the widget for implementing a secondary transaction. The body element of the illustrative code further includes a button 706 that, as indicated by the comment, invokes the handleClick function contained in the launch.js file.

FIG. 8 shows an illustrative JavaScript code contained within the launch.js file for implementing the described secondary transaction widget. It begins with an addEventListener method 800 that calls a function when the browser processes the HTML code for the page. The called function is “addEventListener” 810, and it in turn invokes an addEventListener method of the button 706, linking the button's click event to the “handleClick” function 820.

When the handleClick function 820 is invoked, line 822 retrieves the savedData item from the sessionStorage property. The illustrative code then provides two examples of how the savedData item might be used for a secondary transaction. In example 824, the savedData item is passed to an embedded iframe for further processing. In example 826, the savedData item is passed to the servers for the second website as part of a resource fetch request. Thereafter, line 828 of the handleClick function may affirmatively delete the savedData item so that it cannot be re-used.

It is noted that the modifications to the HTML code for an existing payment information page and confirmation page to enable secondary transactions can be kept to nothing more than the two script elements 502, 702, to facilitate the addition of this feature to existing systems. The bulk of the implementation detail can then be kept within the embedded executable code, which is expected to remain largely unchanged when reused.

In contrast to existing technologies such as auto-fill, tokenization, and digital wallets, the disclosed system may offer certain advantages. Unlike auto-fill technologies, which typically involve long-term storage of user data and require user review before form submission, the disclosed system facilitates short-term storage of data and can directly encrypt and transmit the data without requiring user review. Unlike tokenization systems, which replace original user-entered data with a token and require an intermediary to handle the underlying user-entered data, the disclosed system retains the original user-entered data (or an encrypted form thereof) locally and does not require an intermediary and associated support for communications between distinct backend systems. Unlike digital wallets, which require users to add their cards to the wallet and involve an intermediary, the disclosed system does not require these steps. The use of the disclosed system is not dependent on digital wallet support from either the primary or secondary transaction systems, and it may advantageously limit the reuse of the sensitive data by only one specific secondary transaction system, in contrast with digital wallets, which allow payments to any merchant systems that support use of the digital wallet. Additionally, the disclosed system only stores data for a short period of time within the user's own browser, providing a level of security and data control not typically found in digital wallet systems.

In at least some contemplated embodiments, the disclosed system employs public key encryption to enhance the security of the stored data, ensuring that only the intended recipient of the data can decrypt it, contingent upon user approval. This pre-encryption feature further distinguishes the disclosed system from existing technologies and provides an additional layer of security for sensitive user data. Moreover, the stored data is ephemeral, avoiding many of the compliance issues that would otherwise be required for indefinitely retaining protected consumer information.

A number of implementations have been described. Nevertheless, it will be understood that various modifications may be made without departing from the spirit and scope of the disclosure. Accordingly, other implementations are within the scope of the following claims. Though for explanatory purposes the operations shown and described in FIG. 3 are treated as being largely sequential, in practice the process is carried out by multiple systems and modules operating concurrently and perhaps even with speculative completion. The sequential discussion is not meant to be limiting. These and numerous other modifications, equivalents, and alternatives, will become apparent to those skilled in the art once the above disclosure is fully appreciated.

The term “non-transitory computer-readable medium” is directed to nonvolatile information storage media that retains digital information indefinitely without power, and can take various forms such as solid-state drives, hard disk drives, optical discs, flash memory, magnetic tape. It will be appreciated by those skilled in the art that the words “during”, “while”, and “when” as used herein are not exact terms that mean an action takes place instantly upon an initiating action but that there may be some small but reasonable delay(s), such as various propagation delays, between the reaction that is initiated by the initial action. Additionally, the term “while” means that a certain action occurs at least within some portion of a duration of the initiating action. The use of the word “approximately” or “substantially” means that a value of an element has a parameter that is expected to be close to a stated value or position. The terms first, second, third and the like in the claims or/and in the description, particularly as used in a portion of a name of an element, are used for distinguishing between similar elements and not for describing a sequence, either temporally, spatially, in ranking or in any other manner. It is to be understood that the terms so used are interchangeable under appropriate circumstances and that the embodiments described herein are capable of operation in other sequences than described or illustrated herein. Inventive aspects may lie in less than all features of any one given implementation example. Furthermore, while some implementations described herein include some but not other features included in other implementations, combinations of features of different implementations are meant to be within the scope of the invention, and form different embodiments as would be understood by those skilled in the art.

What is claimed is:

1. A payment system that comprises:
a first set of one or more servers for a first website, the first set of servers collectively configured to:
provide a payment information form page;
process payment information to determine a primary transaction status; and
provide a confirmation page,
wherein the payment information form page configures a client device to:
accept payment information from a user;
convey the payment information to the first set of one or more servers; and
store the payment information in a temporary storage location, and
wherein the confirmation page, or a subsequent page reachable via the confirmation page, configures the client device to:
obtain a user decision regarding a secondary transaction;
send, without requiring completion of another payment information form, the payment information to a second set of one or more servers for a second website if the user decision is affirmative; and
delete the payment information from the temporary storage location before, or upon, closure of the confirmation page or the subsequent page.

2. The payment system of claim 1, wherein the temporary storage location holds the payment information in encrypted form and said storing includes using a public key to generate the encrypted form, wherein the public key is associated with the second website.

3. The payment system of claim 2, wherein said sending includes transmitting the encrypted form of the payment information retrieved from the temporary storage location.

4. The payment system of claim 1, wherein the client device employs an internet browser to render the payment information form page and the confirmation page.

5. The payment system of claim 4, wherein the temporary storage location is memory allocated to a local variable in a runtime environment for the internet browser.

6. The payment system of claim 4, wherein the temporary storage location is an HTTP cookie associated with the first website.

7. The payment system of claim 1, wherein the temporary storage location has a timeout that triggers deletion of the payment information if not previously deleted.

8. The payment system of claim 1, wherein the confirmation page, or a subsequent page reachable via the confirmation page, configures the client device to delete the payment information upon determining that the user decision is negative.

9. A method for facilitating secure payments, the method comprising:
rendering a payment information form page for a first website;
accepting via the payment information form page payment information from a user;
conveying the payment information to a first set of set of one or more servers for the first website;
storing the payment information in a temporary, local storage location;
displaying a confirmation page for the first website;
obtaining via the confirmation page or via a subsequent page reachable from the confirmation page, a user decision regarding a purchase transaction from a second website;
sending, without requiring completion of a payment information form for the second website, the payment information to a second set of one or more servers for the second website if the user decision is affirmative; and
deleting the payment information from the temporary storage location before, or upon, closure of the confirmation page or the subsequent page.

10. The method of claim 9, wherein the temporary storage location holds the payment information in encrypted form and said storing includes using a public key to generate the encrypted form, wherein the public key is associated with the second website.

11. The method of claim 10, wherein said sending includes transmitting the encrypted form of the payment information retrieved from the temporary storage location.

12. The method of claim 9, wherein said rendering, accepting, conveying, and storing operations are implemented by an internet browser responsive to instructions for providing the payment information page, and wherein said displaying, obtaining, sending, and deleting operations are implemented by the internet browser responsive to instructions for providing the confirmation page or the subsequent page.

13. A non-transitory computer-readable medium storing instructions that, when incorporated in a confirmation form page of a first website accessed by an internet browser on a client device, configures a processor to:
obtain a user decision regarding a secondary transaction;
send, if the user decision is affirmative and without requiring completion of a payment information form associated with a second website, payment information previously stored by the internet browser in a temporary, local storage location in response to a primary transaction with the first website; and
delete the payment information from the temporary storage location before, or upon, closure of the confirmation page.

14. The non-transitory computer-readable medium of claim 13, wherein the temporary storage location holds the payment information in encrypted form generated using a public key associated with the second website.

15. The non-transitory computer-readable medium of claim 13, wherein the temporary storage location is memory allocated to a local variable in a runtime environment for the internet browser.

16. A payment system that comprises:
a first set of one or more servers for a first website having at least one page that configures a client device to store, in a temporary storage location, encrypted payment information encrypted using a public key associated with a second website, the first website further having a subsequent page that configures the client device to:
obtain a user decision regarding a secondary transaction;
send the encrypted payment information from the temporary storage location to a second set of one or more servers for a second website if the user decision is affirmative; and
delete the payment information from the temporary storage location before, or upon, closure of the subsequent page.

17. The payment system of claim 16, wherein the client device employs an internet browser to render the payment information form page and the confirmation page.

18. The payment system of claim 17, wherein the temporary storage location is memory allocated to a local variable in a runtime environment for the internet browser.

19. The payment system of claim 16, wherein the temporary storage location has a timeout that triggers deletion of the payment information if not previously deleted.

20. The payment system of claim 16, wherein the subsequent page configures the client device to delete the payment information upon determining that the user decision is negative.
